(19) United States
(12) Patent Application Publication
(10) Pub. No.: US 2017/0047768 A1
(43) Pub. Date: Feb. 16, 2017

(54) TRANSMISSION SYSTEM, METHOD FOR INDUCTIVELY CHARGING AN ELECTRICALLY DRIVEN VEHICLE, AND VEHICLE ASSEMBLY

(71) Applicant: Robert Bosch GmbH, Stuttgart (DE)

(72) Inventors: Tobias Diekhans, Stuttgart-Vaihingen (DE); Oliver Blum, Renningen (DE); Philipp Schumann, Stuttgart (DE)

(21) Appl. No.: 15/305,726

(22) PCT Filed: Feb. 25, 2015
(86) PCT No.: PCT/EP2015/053875

§ 371 Date: Oct. 21, 2016

(30) Foreign Application Priority Data
Apr. 25, 2014 (DE) 10 2014 207 854.7

(51) Int. Cl. H02J 7/02; H02M 5/458; B60L 11/18; H02J 50/12

(52) U.S. Cl. CPC H02J 7/025; H02J 50/12; H02M 5/4585; B60L 11/182; B60L 2210/20

(57) ABSTRACT

The invention relates to a transmission system for transmitting energy to a load without contact, comprising a transmission device for transmitting electrical energy without contact, an inverter device, which is arranged between an energy source that provides supply power and the transmission device and which is designed to transmit electrical energy from the energy source to the transmission device, a rectifier device, which is arranged between the transmission device and the load and which is designed to transmit the electrical energy from the transmission device to the load, wherein the inverter device is designed to set the amount of the transmitted electrical power by means of pulse pattern modulation of the energy source and/or the rectifier device is designed to set the amount of the transmitted electrical power by means of pulse pattern modulation of power provided by the transmission device. The invention further relates to a method and to a vehicle assembly.

### BACKGROUND OF THE INVENTION

The present invention relates to a transmission system for the contactless transmission of energy. Furthermore, the present invention relates to a corresponding method and a vehicle assembly.

Today, electrical energy stores are used in a variety of applications. For example, batteries are used as energy stores in particular in mobile applications.

For example, batteries are used in electric vehicles or hybrid vehicles as energy stores in order to provide energy for the electric drive motor of the electric vehicle or hybrid vehicle.

In order to be able to use a battery as an energy store in a vehicle, a way must also be provided to charge the battery.

Today, it is customary to charge high-voltage batteries in a vehicle, for example, via a galvanic connection to the public power grid. In addition, a charging adapter may be installed, for example, in a garage of a house, to which the particular vehicle may be connected via a cable. Alternatively, the charging adapter is present on the vehicle side and may be connected to a conventional socket.

EP2623363 shows a conventional charging device for energy stores.

Furthermore, today, inductive charging assemblies are known in which energy is transmitted from the charging adapter to the vehicle wirelessly via an inductive coupling of two coils.

In the case of so-called inductive charging of electric vehicles, the energy required for charging the vehicle battery is not transmitted to the vehicle via a charging cable (conductive charging); rather, it is transmitted contactlessly via a transformer having a large air gap. In this case, the primary coil of the transformer is typically either embedded in the floor or formed as a charging plate placed on the floor and is connected to the power grid via a suitable electronic system. The secondary coil of the transformer is typically fixedly installed in the subfloor of the vehicle and is, for its part, connected to the vehicle battery by means of a suitable electronic system. For energy transmission, the primary coil generates a high-frequency magnetic alternating field which penetrates the secondary coil and induces a corresponding current there.

Since, on the one hand, the transmittable power scales linearly with the switching frequency, and on the other hand, the switching frequency is limited by the control electronics, losses in the transmission path, and legal limit values with respect to magnetic fields, a typical frequency range of 10 to 150 kHz results.

FIG. 10 shows a conventional inductive charging assembly. The centerpiece of the electronic system which connects the primary coil to the power grid is an inverter which is operated at a high switching frequency. The current flow typically results via excitement of the oscillating circuit formed by the primary coil and a corresponding compensation capacitor. In this case, various resonant assemblies having additional resonant elements are in principle possible.

In this case, the resonant load may be used to operate the inverter in the so-called zero-voltage switching (ZVS) mode and/or zero-current switching (ZCS) mode. In this fully resonant operation, only slight switching losses result in the semiconductor components used for switching. The combination of the two oscillating circuits including an inverter and rectifier may be designed for charging a battery having a specified voltage range and corresponding charging power.

If, for example, so-called series-series compensation including series oscillating circuits on the primary and secondary side is used as a resonant arrangement, it thus results that the primary coil current is a function of the battery voltage, but not of the charging current. Since the line losses in the coils and in the inverter contribute significantly to the overall system losses, it becomes clear that this assembly has significantly increasing losses and thus significantly lower overall energy transmission efficiency relative to the transmission power in the case of partial-load operation, i.e., reduced charging current. This problem may be remedied via a reduction of the secondary voltage of the system (predetermined in the described structure by the battery). One current approach is the use of an additional DC/DC converter or impedance transformer (active or passive) on the secondary side. However, such a converter on the secondary side, i.e., in the vehicle, is disadvantageous due to weight and installation space restrictions and due to losses in switching elements and/or passive components.

### SUMMARY OF THE INVENTION

The present invention provides a transmission system, a method, and a vehicle.

Accordingly, the following is provided:

A transmission system for the contactless transmission of energy to a consumer, including a transmission device for the contactless transmission of electrical energy, including an inverter device which is arranged between an energy source which provides supply power and the transmission device and is designed to transmit electrical energy from the energy source to the transmission device, including a rectifier device which is arranged between the transmission device and the consumer and is designed to transmit the electrical energy from the transmission device to the consumer, wherein the inverter device is designed to regulate the transmitted electrical power via a pulse pattern modulation of the control signals of the inverter device, and/or the rectifier device is designed to regulate the transmitted electrical power via a suitable pulse pattern modulation of the rectifier device.

Furthermore, the following is provided:

A method for the contactless transmission of energy to a consumer, including the steps of cyclically switching electrical supply power of an energy source to a transmission device which is designed for the contactless transmission of electrical energy, contactlessly transmitting the electrical energy in the transmission device, cyclically switching electrical power provided by the transmission device to the consumer, wherein in at least one of the steps of cyclically switching, the respective power is regulated via pulse pattern modulation.

Finally, the following is provided:

A vehicle assembly including a transmission system according to the present invention, including a vehicle, wherein the rectifier device is arranged in the vehicle, and wherein the inverter device is arranged outside the vehicle, and wherein the transmission device is at least partially arranged in the vehicle and partially outside the vehicle.

The present invention is based on the finding that the use of additional impedance transformers entails additional complexity and reduces the overall efficiency.

The present invention is now based on the idea of taking this finding into account and providing a transmission system in which the impedance transformers, for example, DC/DC converters of the related art, are replaced by a suitable switching strategy in the inverter device and/or the rectifier device.

Accordingly, the present invention provides a transmission system in which an inverter device and/or a rectifier device is able to regulate the power at all design-relevant operating points while maintaining the desired ZVS (zero-voltage switching) and/or ZCS (zero-current switching) operating mode (soft-switching operation). In this case, pulse pattern modulation may be understood to mean that the inverter device and/or the rectifier device are activated in such a way that the transmission device is activated by positive and negative pulse-like signals, for example, square-wave signals. The pulse pattern modulation comprises controlling the frequency, number, or sequence of these pulse-like signals. In the case of the inverter device, this may mean that the transmission system is activated by a square-wave signal of a fundamental frequency with omitted half waves or full waves, instead of by a single-frequency square-wave signal. In the case of the rectifier device, this means that not all half waves or full waves of the current signal transmitted by the transmission device are rectified and thus conveyed to the consumer; rather, some half waves or full waves are omitted via a controlled short circuit of the rectifier input and recirculate in the secondary oscillating circuit of the transmission device.

In soft-switching topologies, which may also be used in particular at higher transmission power and higher transmission frequency, the semiconductor switches are activated only at very low current near the zero crossing of the periodic current signal, or at very low voltage while the parallel freewheeling diode conducts the current.

If only entire sinusoidal half waves are masked out during power modulation, the so-called soft switching is also still possible in the case of partial loading, in contrast to other modulation types. By omitting half waves, a lower voltage is applied to the transmission device on average over time, without the voltage having to be regulated, for example, by a DC/DC converter.

The present invention thus provides a system design which, on the one hand, constitutes minimum hardware complexity, since no additional passive and active elements are required, and on the other hand, achieves optimal efficiency even at high power, full-load operation, and partial load operation. In addition, the topology and the switching strategy may be used at high frequencies, which is made possible by the soft-switching operation.

In one specific embodiment, the fundamental frequency or an integer multiple of the fundamental frequency corresponds to the pulse pattern modulation of the resonant frequency of the transmission device.

In one specific embodiment, both the inverter device and the rectifier device are designed to regulate the power at all design-relevant operating points, wherein the desired ZVS (zero-voltage switching) and/or ZCS (zero-current switching) operating mode is maintained (using soft-switching operation). If both the inverter device and the rectifier device are operated in such a way that they both contribute to the power regulation, the operating point may be optimally set via a suitable two-sided regulation strategy.

In an additional specific embodiment, the transmission system includes a control device which is coupled to the inverter device and the rectifier device and has a switching pattern having a predefined or variable length for the inverter device and/or for the rectifier device, for a plurality of operating points of the transmission system, wherein each position of the switching pattern indicates a half wave or a full wave of the particular voltage or the particular electric current, wherein the control device is designed to control the inverter device and/or the rectifier device as a function of one of the switching patterns.

In an additional specific embodiment, the control device is designed to synchronize the switching of the inverter device and the switching of the rectifier device. If the switching operations of the inverter device and the rectifier device are synchronized, the switching strategy may be optimized, and the efficiency may be improved, and reactive currents in the system may thereby be reduced.

In one specific embodiment, the control device carries out an operating strategy in which the rectifier device in the vehicle and the inverter device in the charging station set their respective level of power modulation in such a way that, taking into consideration the determined constraints such as the coupling factor of the coils and the battery voltage, as well as the desired transmission power, an optimal operating point of the overall system is achieved with respect to loading of the components, the magnetic leakage field, heat dissipation, and transmission losses.

For this purpose, in one specific embodiment, the control device may use identical pulse patterns on the primary side and the secondary side. For this operating strategy, no additional measuring technology (for example, for ascertaining the coupling inductance M) would be necessary in comparison to the conventional one-sided regulation. The only prerequisite is an existing communication between the primary side and the secondary side. The controlled variable (for example, the battery charging current) must be measured in any case.

The objective of a second operating strategy would be to adjust a constant current ratio between the current on the primary side and the current on the secondary side via a suitable pulse pattern on the primary side and the secondary side. The same advantages result as with the previous operating strategy. In addition, the actual battery voltage is decoupled from the system by the secondary side, so that the same currents flow both on the primary side and on the secondary side as at the nominal point for which the system was optimized. Accordingly, impedance matching occurs via the active secondary side without the need for an additional DC/DC converter.

A third operating strategy provides for an adaptive operating point adjustment. An optimal operating point may now be adaptively set under the constraint that a required power is to be transmitted at a given coupling factor and a given battery voltage. This is made possible via the additional degree of freedom which the two-sided regulation provides. In one exemplary embodiment, for example, a measurement of the actual efficiency and an adaptive setting of the most efficient operating point are possible. The process may proceed very slowly from a regulating point of view, since the operating point changes slowly during the charging process. Other optimization variables are possible, for example, the charging process having a minimal B-field in the air gap.

Finally, a fourth operating strategy may be used, which provides for an active secondary side for increasing the operating range of the overall system. The secondary side is actively used for impedance matching only if the primary current exceeds an established maximum value, for example, due to a poor coupling factor, in order to be able to continue to operate the system without exceeding the maximum primary current.

In an additional exemplary embodiment, the synchronization of the pulse pattern modulation of the inverter device and the rectifier device takes place by measuring one or multiple electrical variables, for example, a current. Thus, fast communication is not required, or no communication at all is required, for synchronizing the inverter device and the rectifier device.

In one specific embodiment, the control device is designed to control the inverter device and the rectifier device in such a way that the current amplitudes and losses on both sides of the transmission device are approximately constant or are matched to the ohmic resistance of the resonant circuits.

In an additional specific embodiment, the time spans of the activation or deactivation in the inverter device and the rectifier device are chosen in such a way that the relative losses are minimized during energy transmission.

In one specific embodiment, the control device is distributed between the inverter device and the rectifier device. A data transmission for synchronization may take place between the two parts, for example, via a radio connection, a wired connection, or the like. Alternatively, the inverter device and the rectifier device each include a control device which carries out the synchronization in each case with the aid of a current and/or voltage measurement.

In one specific embodiment, the inverter device includes a bridge circuit. In this case, the bridge circuit may have a half bridge or a full bridge. In addition or alternatively, the rectifier device has two negative rectifier branches, each including a second switching element including a second diode which is reverse-connected in parallel to each second switching element, and two positive rectifier branches, each including a third diode. As a result, in the case of suitable activation of the switching elements, it is possible to close both the oscillating circuit on the input side of the transmission device and the oscillating circuit on the output side of the transmission device and to decouple them from the additional components. As a result, the energy input into, or the energy withdrawal from, the respective oscillating circuit may be prevented or controlled.

Alternatively, the rectifier device may also be designed as an inverter device which is in particular identical to the inverter device according to the present invention. As a result, a bidirectional energy transmission is made possible.

The embodiments and refinements mentioned above may be combined in any arbitrary manner if meaningful. Additional possible embodiments, refinements, and implementations of the present invention also include combinations not explicitly mentioned of features of the present invention described previously or hereinafter with respect to the exemplary embodiments. In particular, those skilled in the art will also add individual aspects as improvements or refinements to each basic form of the present invention.

### BRIEF DESCRIPTION OF THE DRAWINGS

The present invention is described in greater detail below based on the exemplary embodiments specified in the schematic figures of the drawings. The following are shown:

FIG. 1 shows a block diagram of one specific embodiment of a transmission system according to the present invention;

FIG. 2 shows a flow chart of one specific embodiment of a method according to the present invention;

FIG. 3 shows a block diagram of one specific embodiment of a vehicle assembly according to the present invention;

FIG. 4 shows an electric circuit diagram of one specific embodiment of a transmission system according to the present invention;

FIG. 5 shows a diagram for depicting the voltages and currents in one specific embodiment of a transmission system according to the present invention;

FIG. 6 shows an additional diagram for depicting the voltages and currents in one specific embodiment of a transmission system according to the present invention;

FIG. 7 shows an additional diagram for depicting the voltages and currents in one specific embodiment of a transmission system according to the present invention;

FIG. 8 shows an additional diagram for depicting the voltages and currents in one specific embodiment of a transmission system according to the present invention;

FIG. 9 shows an additional diagram for depicting the voltages and currents in one specific embodiment of a transmission system according to the present invention; and

FIG. 10 shows a block diagram of a conventional charging assembly.

In all figures, identical or functionally identical elements and devices have been provided with the same reference numerals, unless stated otherwise.

### DETAILED DESCRIPTION

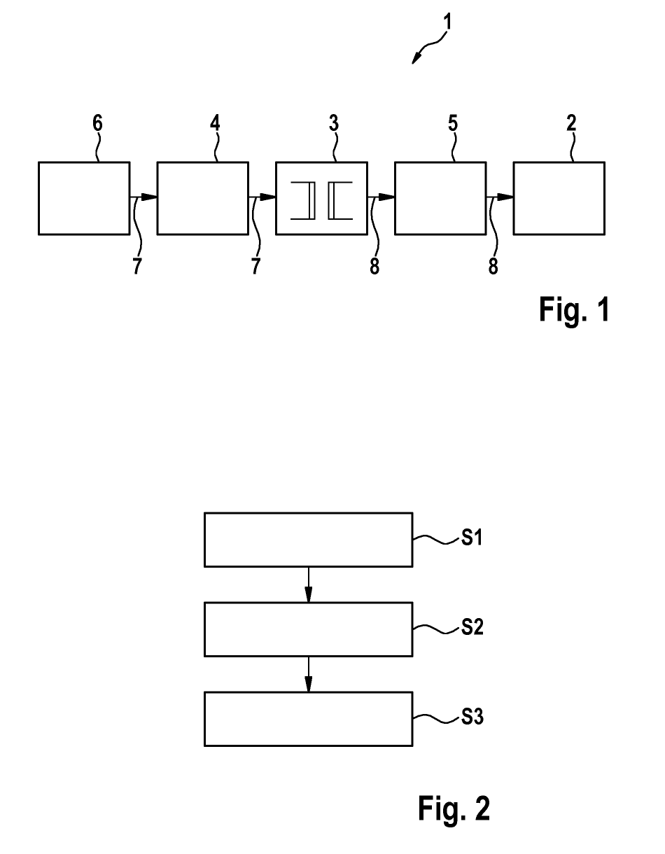

FIG. 1 shows a block diagram of one specific embodiment of a charging system 1 according to the present invention.

The transmission system of FIG. 1 has an energy source 6 which is coupled to an inverter device 4. The inverter device 4 is coupled to a transmission device 3, and the transmission device 3 is coupled to a rectifier device 5, which in turn is coupled to a consumer 2. In one specific embodiment, the consumer 2 may be designed, for example, as an energy store 2, for example, a battery 2. However, the consumer may also be designed as any other type of electrical consumer.

The energy source provides supply power 7, which the inverter device 4 converts into supply power 7 for the transmission device 3. The supply power 7 for the transmission device 3 may, for example, have an alternating voltage or an alternating current.

The transmission device 3 may transmit electrical energy or power contactlessly; this is merely depicted by way of example in FIG. 1 as two coils which are arranged opposite each other. If the transmission device 3 is achieved via coils 3-1, 3-2, each coil has an additional capacitor (not depicted) which, together with the respective coils 3-1, 3-2, forms an oscillating circuit.

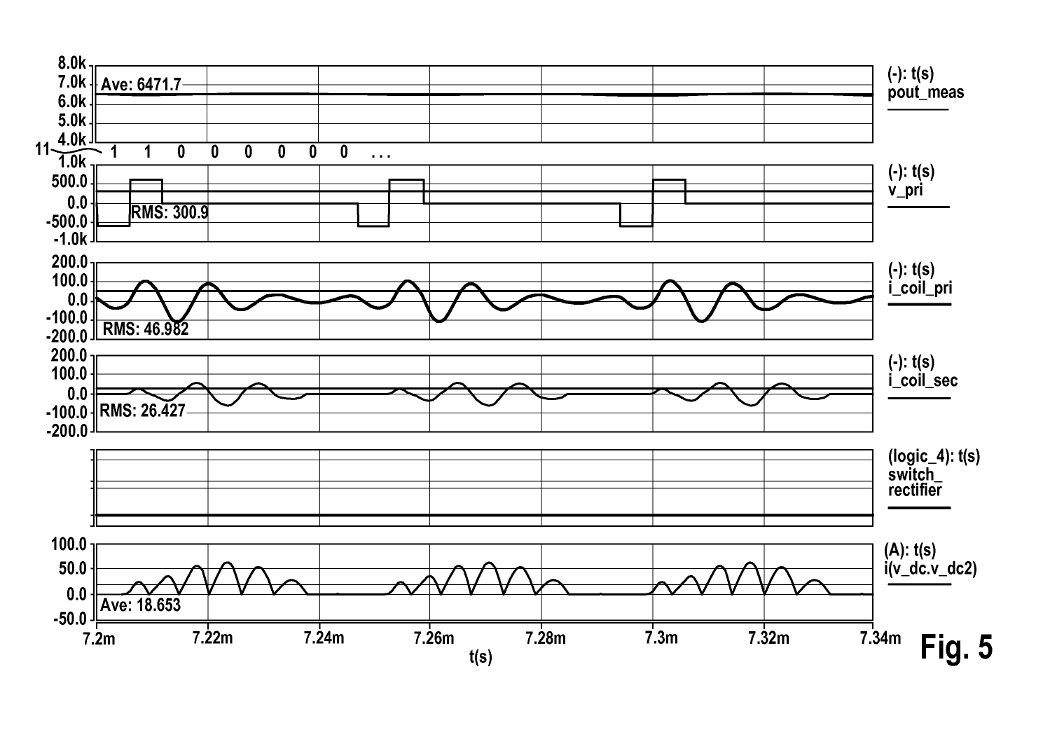

An omission of half waves or full waves in the inverter device 4 is used for power regulation in the inverter device 4. An effectively lower excitation amplitude of the primary-side oscillating circuit is thereby achieved. During the oscillation breaks, the inverter device 4 is set in such a way that a freewheeling state results which allows a continued oscillation of the oscillating circuit. This will be explained in greater detail in connection with FIG. 5.

The power regulation by the rectifier device 5 is carried out according to the present invention via the introduction of a switchable freewheeling state in the rectifier device 5. Here as well, it is provided that one or multiple half waves or full waves are omitted or masked out. Thus, here as well, the switching strategy according to the present invention provides for activating a freewheeling state for short-circuiting the secondary-side oscillating circuit over at least one half wave of the current signal. Therefore, no current flows into the battery while the secondary-side oscillating circuit is short-circuited. As a result, the circuit “sees” an effectively lower battery voltage upstream from the rectifier device, which results in a significantly smaller current flow in the coil on the side of the energy source, thus resulting in reduced losses.

Via a combination of the pulse pattern modulation of the power in the inverter device 4 and the rectifier device 5, any arbitrary operating point may thus be set for the transmission system 1.

With the aid of the present invention, it is not only possible to reduce components in the transmission system 1. In fact, the transmission system 1 may also be operated in partial-load operation at high efficiency.

FIG. 2 shows a flow chart of one specific embodiment of a method according to the present invention.

In a first step S1, the method provides for cyclically switching electrical supply power 7 of an energy source 6 to a transmission device 3 which is designed for the contactless transmission of electrical energy.

In a second step, the electrical energy is contactlessly transmitted, for example, from a transmitting coil or primary coil 3-1 of a transmission device 3 to a receiving coil or secondary coil 3-2 of the transmission device 3 mounted in a vehicle.

In a third step S3, the power 8 provided by the transmission device 3 is cyclically switched or conveyed to the consumer 2.

In this case, the switching operations in at least one of the steps of cyclically switching S1, S3 are modulated in pulse patterns. Alternatively, pulse pattern modulation may also be carried out in both steps of cyclically switching S1 and S3.

In addition, in one specific embodiment, the steps of cyclically switching may be synchronized.

Finally, in one specific embodiment, for the cyclical switching operations, one switching pattern 11 having a predefined or variable length may be predefined in each case for a plurality of operating points of the transmission method.

In this case, a separate switching pattern may be predefined in each case for the switching operations in the inverter device 4 and in the rectifier device 5.

Each of the positions of the switching pattern 11 identifies a half wave or a full wave of the particular voltage or the particular current on the basis of which switching occurs.

Based on the switching patterns 11, the power levels in the inverter device 4 and in the rectifier device 5 may subsequently be switched in order to set a desired operating point when charging.

The method according to the present invention may implement various strategies. In one specific embodiment, an operating strategy is used in which the rectifier device and the inverter device set their respective level of power modulation in such a way that, taking into consideration the determined constraints such as the coupling factor of the coils and battery voltage, as well as the desired transmission power, an optimal operating point of the overall system is achieved with respect to loading of the components, the magnetic leakage field, heat dissipation, and transmission losses.

For this purpose, in one specific embodiment, identical pulse patterns may be used on the primary side and the secondary side. For this operating strategy, no additional measuring technology (for example, for ascertaining the coupling inductance M) would be necessary in comparison to the conventional one-sided regulation. The only prerequisite is an existing communication between the primary side and the secondary side. The controlled variable (for example, of the battery charging current) must be measured in any case.

The objective of a second operating strategy would be to adjust a constant current ratio between the current on the primary side and the current on the secondary side via a suitable pulse pattern on the primary side and the secondary side. The same advantages result as is the case with the previous operating strategy. In addition, the actual battery voltage is decoupled from the system by the secondary side, so that the same currents flow on both the primary side and on the secondary side as at the nominal point for which the system was optimized. Accordingly, impedance matching occurs via the active secondary side without the need for an additional DC/DC converter.

A third operating strategy provides for an adaptive operating point adjustment. An optimal operating point may now be adaptively set under the constraint that a required power is to be transmitted at a given coupling factor and a given battery voltage. This is made possible via the additional degree of freedom which the two-sided regulation provides. In one exemplary embodiment, for example, a measurement of the actual efficiency and an adaptive setting of the most efficient operating point is possible. This process may proceed very slowly from a regulating point of view, since the operating point changes slowly during the charging process. Other optimization variables are possible, for example, the charging process having a minimal B-field in the air gap.

Finally, a fourth operating strategy may be used, which provides for an active secondary side for increasing the operating range of the overall system. The secondary side is actively used for impedance matching only if the primary current exceeds an established maximum value, for example, due to a poor coupling factor, in order to be able to continue to operate the system without exceeding the maximum primary current.

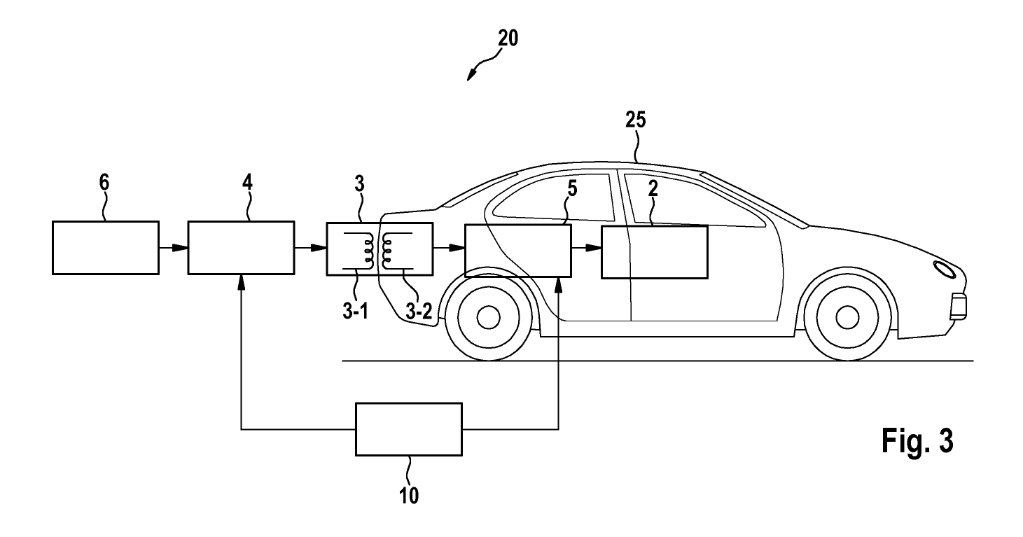

FIG. 3 shows a block diagram of one specific embodiment of a vehicle assembly 20 according to the present invention.

A vehicle 25 is depicted in the vehicle assembly 20, wherein the receiving coil 3-2 of the transmission device 3, the rectifier device 5, and the consumer 2 designed as an energy store 2, for example, a vehicle battery 2, are arranged inside the vehicle 25.

The energy source 6, the inverter device 4, and the primary coil 3-1 of the transmission device 3 are arranged outside the vehicle 25.

Finally, a control device 10 is provided which is coupled to the inverter device 4 and the rectifier device 5 in order to control them.

The control device 10 may be designed to carry out a method according to FIG. 2. In this case, the control device 10 may be designed as a single control device 10. Alternatively, the control device 10 may also be designed as a distributed control system 10 which may be partially arranged in the inverter device 4 and partially in the rectifier device 5. In this case, the parts of the control device may exchange data for synchronization, for example, via radio. Alternatively, the parts of the control device 10 may also carry out the synchronization based on a current or a voltage measurement.

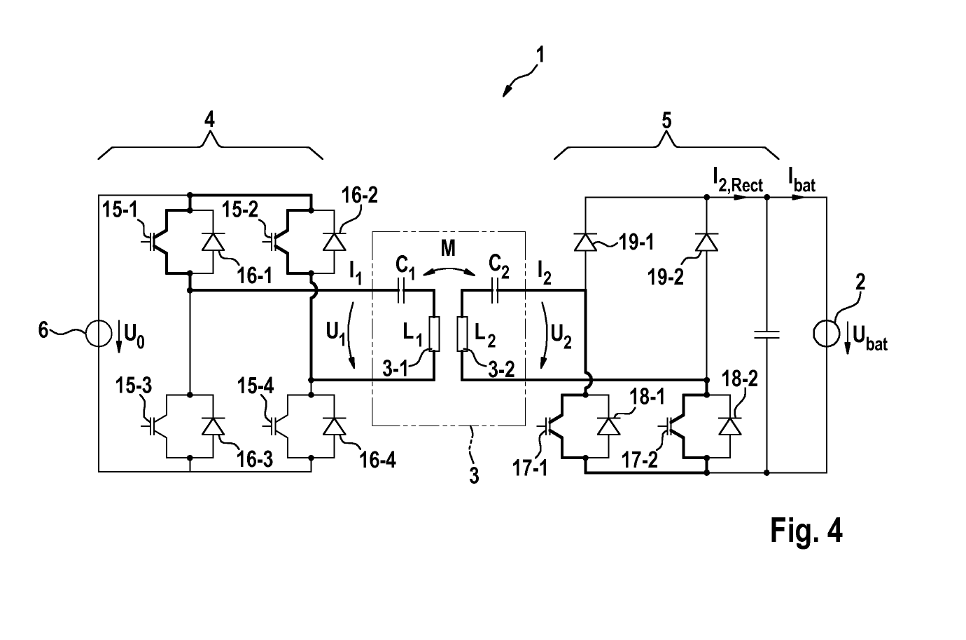

FIG. 4 shows an electric circuit diagram of an exemplary specific embodiment of a transmission system 1 according to the present invention.

The transmission system in FIG. 4 has an energy source 6 which provides a supply voltage U₀. The inverter device 4 has four branches, wherein two branches are coupled to the positive terminal of the energy source 6, and two branches are coupled to the negative terminal of the energy source 6. One branch which is coupled to the positive terminal and one branch which is coupled to the negative terminal are each coupled to a first terminal of a transmitting coil 3-1 of the transmission device 3, which includes an inductor L₁. The remaining branches are coupled to a second terminal of the transmitting coil 3-1 of the transmission device 3. Each branch includes a first switching device 15-1 to 15-4 and a first diode 16-1 to 16-4 which is reverse-connected in parallel to each first switching device 15-1 to 15-4. Furthermore, a capacitor C₁ is arranged between the inverter device 4 and the transmitting coil 3-1, which, together with the coil 3-1, forms an oscillating circuit.

The receiving coil 3-2 of the transmission device 3 is coupled to the rectifier device 5. The rectifier device 5 has two branches, each coupling one of the terminals of the receiving coil 3-2 to the negative terminal of the energy store 2. Each of these branches includes a second switching device 17-1 to 17-2 each including a second diode 18-1, 18-2 which is arranged in reverse-parallel. The rectifier device 5 furthermore has two branches, each coupling one of the terminals of the receiving coil 3-2 to the positive terminal of the energy store 2. Each of these branches includes a third diode 19-1, 19-2. Furthermore, a capacitor C₂ is arranged between the rectifier device 5 and the receiving coil 3-2, which, together with the coil 3-2, forms an oscillating circuit.

In FIG. 4, the energy source provides the voltage U₀. The voltage U₁ is present at the oscillating circuit of the transmitting coil 3-1. The current I₁ flows in the oscillating circuit of the transmitting coil 3-1. The voltage U₂ is present at the oscillating circuit of the receiving coil 3-2. The current I₂ flows in the oscillating circuit of the receiving coil 3-2. The energy store 2 has the voltage U_{bat}.

The basic operating behavior of the inductive transmission system may be determined by fundamental harmonic analysis, in which the harmonics of the rectangular voltage signal are neglected. According to fundamental harmonic analysis, the transmitted power is calculated at the resonant frequency ω=ω₀ in the exemplary specific embodiment according to FIG. 4, according to the following formula:

$$P = \frac{{U}_{1} {U}_{2}}{ω M}$$

It is apparent that this power may be influenced by three factors. On the one hand, the secondary-side voltage U₂ may be varied. Furthermore, the primary-side voltage U₁ may be varied. Finally, the coupling factor k between the primary coil 3-1 and the secondary coil 3-2, and thus the coupling inductance M, may be changed. In this case, the coupling factor and the battery voltage are generally predefined by the conditions in the transmission system, for example, by a vehicle, or are not able to be set explicitly.

The voltages U₁ and U₂ may be influenced in a targeted manner via a cyclical activation of the first and second switching elements 15-1 to 15-4 and 17-1 to 17-2. As a result, it is possible to set any arbitrary operating point in the transmission system 1.

In FIG. 4, thick connection lines indicate the current paths via which the oscillating circuit of the primary coil 3-1 and the oscillating circuit of the secondary coil 3-2 may each be closed or may be disconnected from the energy source 6 or the energy store 2.

The path of the oscillating circuit of the primary coil 3-1 runs from a first terminal of the primary coil 3-1 via the capacitor C₁ to the switching element 15-1, via the positive supply line to the switching element 15-2, and from there to the second terminal of the primary coil 3-1. If half waves or full waves are removed or masked out from the supply voltage of the oscillating circuit of the primary coil 3-1 via soft switching, an effectively lower excitation amplitude of the oscillating circuit of the primary coil 3-1 results.

The path of the oscillating circuit of the secondary coil 3-2 runs from a first terminal of the secondary coil 3-2 via the capacitor C₂ to the switching element 17-1, via the negative supply line to the switching element 17-2, and from there to the second terminal of the secondary coil 3-2. Here as well, it is provided to modulate the number of half waves or full waves. Thus, here as well, the switching strategy according to the present invention provides for activating a freewheeling state for short-circuiting the secondary-side oscillating circuit over at least one half wave of the current signal. Therefore, no current flows into the energy store while the secondary-side oscillating circuit is short-circuited. As a result, the circuit “sees” an effectively lower voltage U₂ upstream from the rectifier, which results in a smaller current flow in the primary circuit.

In FIG. 4, the energy source 6 is depicted as a DC-voltage energy source 6. In other specific embodiments, the energy source 6 may also be designed as an AC-voltage energy source including an additional rectifier or the like. For example, the energy source 6 may also be an electrical power supply network of a public power supplier.

The diagrams of FIGS. 5 to 9 show voltages and currents in one specific embodiment of the transmission system 1 according to the present invention according to FIG. 4. Each of the diagrams has six curves which are depicted one above the other. The first curve indicates the profile of the output power of the transmission system 1. The second curve indicates the voltage U₁ in FIG. 4. The third curve indicates the current in the primary coil 3-1, and the fourth curve indicates the current in the secondary coil 3-2. The fifth curve indicates the switch position of the rectifier device 5.

Finally, the sixth curve indicates the profile of the charging current at the energy store 2.

In FIG. 5, furthermore, a switching pattern 11 is depicted between the first and the second curve which specifies when the inverter device carries out its function and inverts the voltage of the energy source 6, and when it does not. In this case, the switching pattern 11 has a value for each half wave of the inverted voltage of the second curve. The switching pattern 11 of FIG. 5 has eight positions and is repeated three times. The switching pattern 11 is “11000000”. Thus, one full wave or one period of the voltage U₁ is transmitted to the transmission device 3, and three other periods are omitted. This corresponds to a sampling ratio of 1/4.

In the third curve, it may be seen that the current in the primary coil 3-1 carries out a transient process with each transmitted full wave, which has almost decayed by the fourth period. Subsequently, one full wave or one period of the voltage U₁ is again transmitted to the transmission device 3, and the transient process starts again. In this example, the maximum amplitude of the current is approximately 100 A.

On the side of the primary coil 3-1, power regulation is possible via the omission of the periods. In this case, the current supplied on average to the primary coil 3-1 is controlled.

In the fourth curve, it is apparent that the current in the secondary coil 3-2 follows the current profile of the current in the second curve. However, its maximum amplitude is somewhat lower, at approximately 50 A. The amplitude of the current in the secondary coil is determined by the coupling factor between the two coils 3-1, 3-2.

In the fifth curve, it is apparent that in the arrangement of FIG. 5, no omission or blanking has taken place on the secondary side. This also becomes clear in the sixth curve, in which it is apparent which current is fed to the energy store 2. This corresponds exactly to the rectified current of the fourth curve.

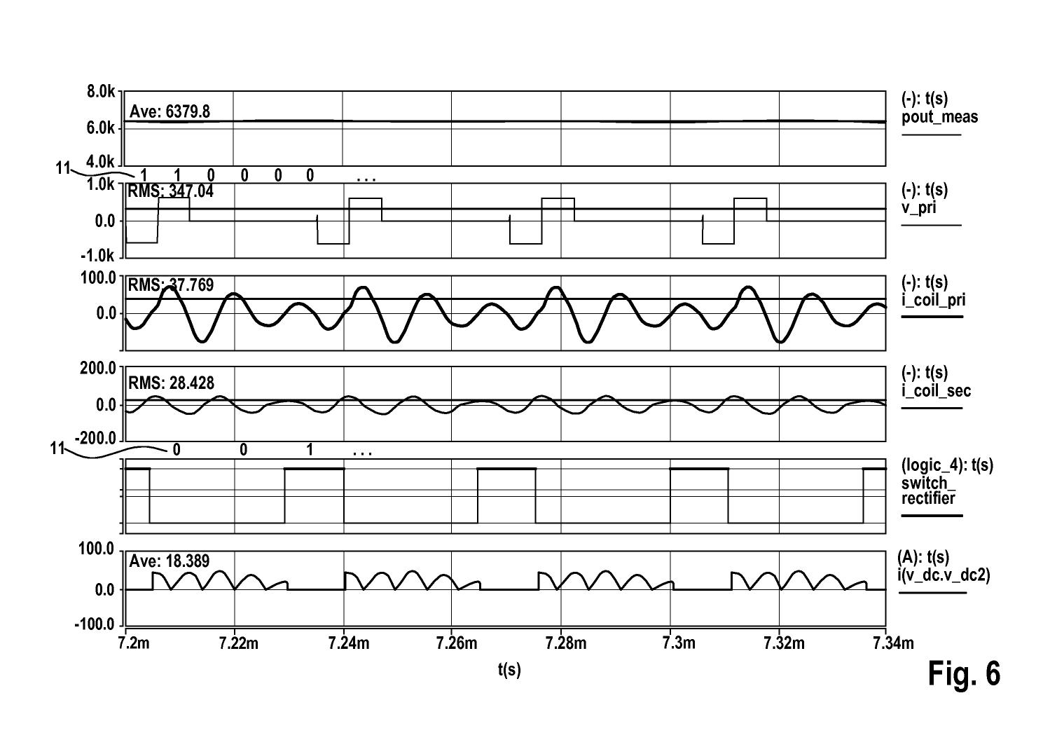

In FIG. 6, the profile of the first and second curves is similar to the profile of the first and second curves of FIG. 5; however, the first curve indicates an average power of 6.38 kW, and the switching pattern of the second curve is “110000”. The rectifier was switched into the freewheeling state approximately 30% of its time. In FIG. 6, the inverter device will thus now transmit 1/3 full waves in FIG. 6 to the transmission device 2 instead of 1/4 full waves as in FIG. 5, in order to reach approximately the same overall power as in the previous example.

The profile of the current in the third curve is identical to the profile of FIG. 5; however, its maximum amplitude is approximately 75 A. The profile of the current in the fourth curve again follows the profile of the current of the third curve.

In the fifth curve, it is apparent that blanking takes place on the secondary side in each case approximately for the duration of one period of the voltage U₁, up to the center of one period of the voltage U₁. The oscillating circuit on the secondary side is thus closed and no energy is withdrawn. This is identifiable in that the amplitude of the current in the secondary oscillating circuit decreases less sharply than in FIG. 5. The corresponding switching pattern 11 for the secondary oscillating circuit is “001”.

The sixth curve shows that no transmission of current to the energy store 2 occurs during the blanking.

While the current in the secondary coil 3-1 has remained approximately constant due to the switching pattern 11 of FIG. 6, the primary coil current has been reduced by 20%. This corresponds to a 35% reduction in the primary coil losses.

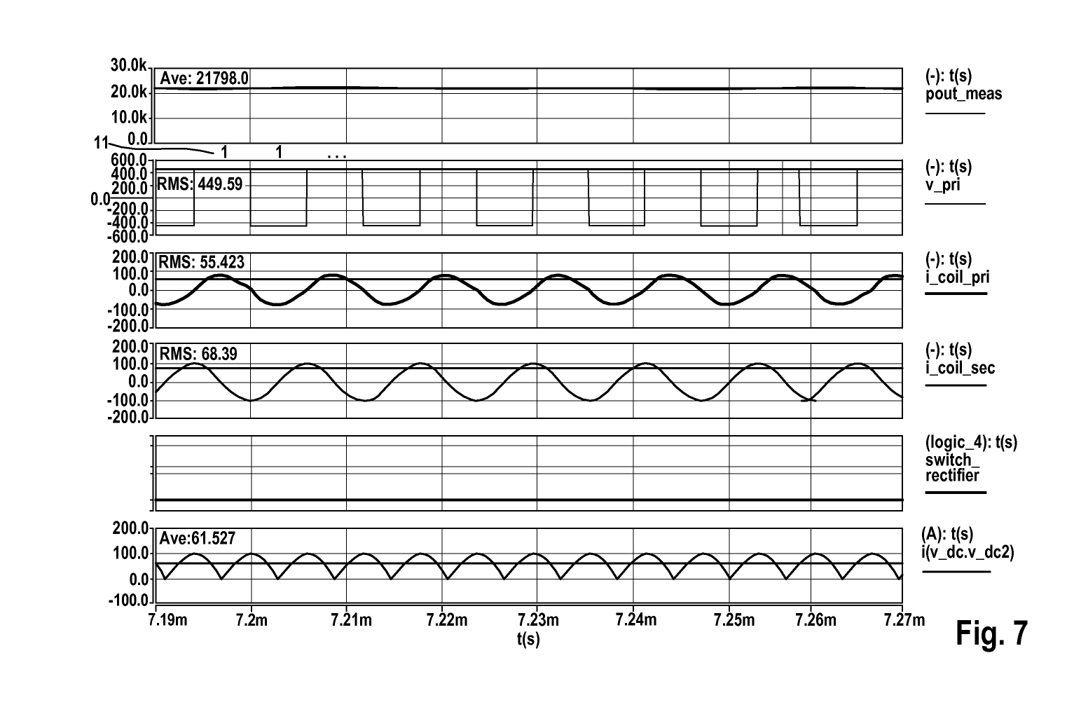

FIG. 7 shows a switching pattern 11 in which each full wave of the voltage U₁ is transmitted. The switching pattern could thus be “11” and be continuously repeated. In the fifth curve of FIG. 7, it is furthermore apparent that no blanking takes place on the secondary side. FIG. 7 shows the behavior of the transmission system 1 at maximum coupling and maximum charging power.

Since no blanking takes place on the primary side, the current flow in the primary coil 3-1 has a sinusoidal, periodic profile. Due to the maximum coupling, the current flow in the secondary coil 3-2 also has a sinusoidal, periodic profile. Both currents have an amplitude of approximately 100 A. The sixth curve shows a continuous transmission of the rectified current of the fourth curve to the energy store 2.

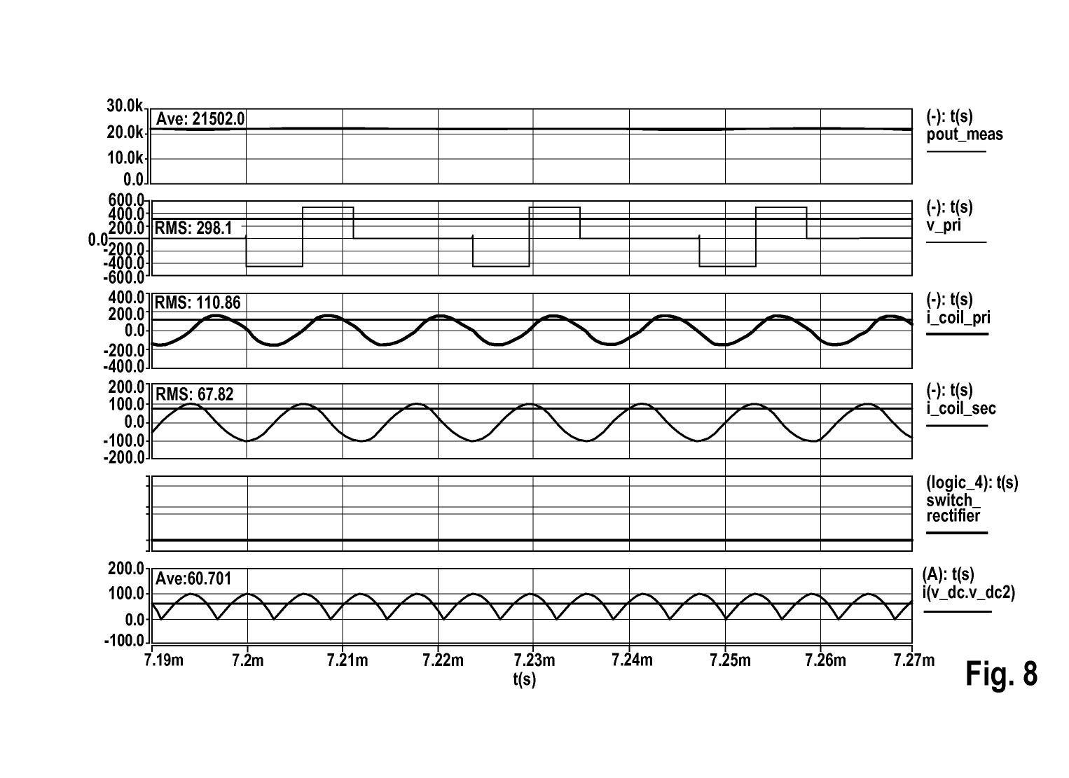

FIG. 8 now shows a switching strategy in which approximately the same power may be transmitted in the transmission system 1 as in FIG. 7. However, the coupling factor in this case is only approximately 50% of the maximum coupling factor of FIG. 7.

At half the coupling coefficient, in order to achieve the full power, the voltage amplitude of the inverted voltage U₁ must be halved, and the current in the primary coil 3-1 must be doubled. For this purpose, every other full wave is omitted in the inverter. A corresponding switching pattern 11 may, for example, be “0011”.

Correspondingly, the second curve shows that only every other full wave of the voltage U₁ is transmitted to the transmission device 2. This results in a doubling of the current in the primary coil 3-1 to approximately 200 A. However, the amplitude of the current in the secondary coil 3-2 remains at 100 A, as in FIG. 7. Thus, approximately the same charging current is obtained on the secondary side as in FIG. 7.

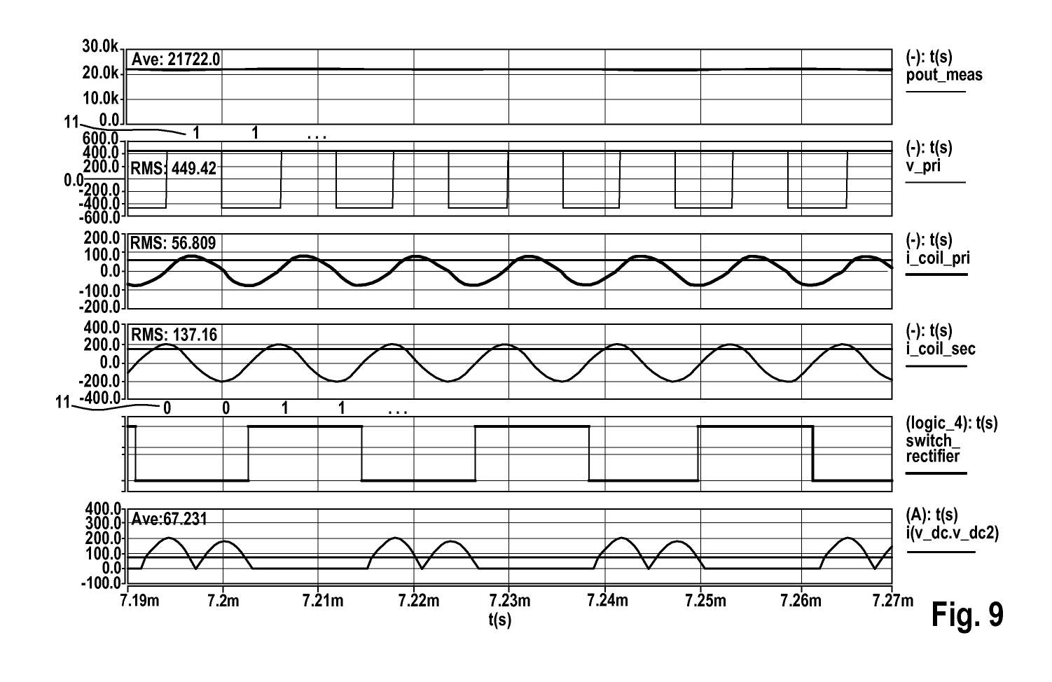

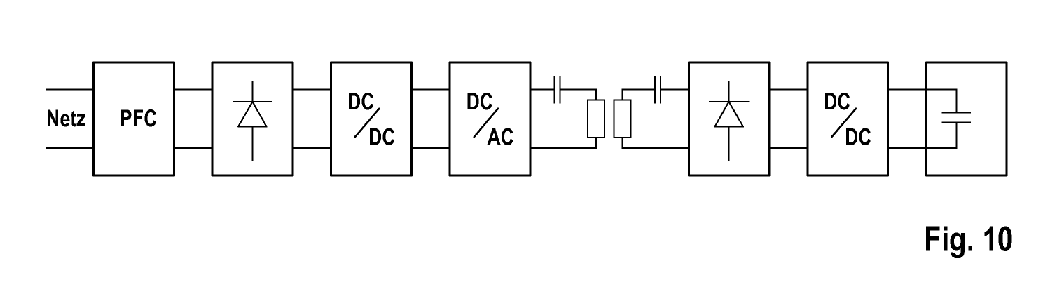

FIG. 9 shows an alternative switching strategy to the switching strategy of FIG. 8, via which an approximately equal power may be transmitted under the same basic conditions.

A charging power which is approximately equal to the one according to the switching strategy of FIG. 8 may also be obtained in that the inverter device 4 is switched without freewheeling; however, instead, blanking takes place in the rectifier device 5 50% of the time. Accordingly, a reduction of the primary coil current to the value achieved at maximum coupling results, while the secondary coil current increases to twice the value, since it becomes active for the battery only half of the time.

Accordingly, the switching strategy of FIG. 9 shows that no blanking takes place, i.e., a switching pattern 11 is, for example, “11”. On the other hand, the switching pattern 11 for the secondary coil 3-2 is applied in such a way that every other full wave is blanked. The switching pattern 11 may, for example, be “0011”.

It is apparent that every other full wave of the current in the secondary coil 3-2 is transmitted to the energy store 2.

FIGS. 5 to 9 show switching strategies for predefined operating points. In other specific embodiments, other switching strategies may comprise combinations of the switching strategies shown above. For example, the blanking of half waves or full waves of the voltage U₁ and the blanking or omission of half waves or full waves of the current in the secondary coil 3-2 may be combined arbitrarily.

In the specific embodiments depicted above, in the switching pattern 11 for the primary side, a “1” means that a half wave of the voltage U₁ is transmitted to the transmission device. For the secondary side, a “1” in the switching pattern 11 means that the corresponding half wave is not transmitted to the energy store 2. This logic may be implemented differently in other specific embodiments. For example, an active-high or an active-low logic may be selected. Furthermore, the length of the switching pattern may vary. In one specific embodiment, the switching pattern has 100 positions. As a result, the power may be regulated very simply in percentage steps, wherein each position represents one percent. Other numbers of positions in the switching pattern 11 are also possible. In addition, in the specific embodiments depicted above, one entire full wave (“11” or “00”) is always switched or masked out. One specific embodiment also according to the present invention provides for the switching or masking out of isolated half waves, for example, “1001001100”.

Although the present invention has been described above based on preferred exemplary embodiments, it is not limited thereto, but may be modified in a variety of ways. In particular, the present invention may be changed or modified in manifold ways without departing from the core of the present invention.

1. A transmission system (1) for the contactless transmission of energy to a consumer (2), the transmission system (1) comprising:
transmitter (3) configured to transmit electrical energy contactlessly,
an inverter (4) positioned between an energy source (6) which provides supply power (7) and the transmitter (3) and configured to transmit electrical energy from the energy source (6) to the transmitter (3);
a rectifier (5) positioned between the transmitter (3) and the consumer (2) and configured to transmit the electrical energy (8) from the transmitter (3) to the consumer (2);
wherein the inverter (4) is configured to set the quantity of transmitted electrical power via a pulse pattern modulation of control signals of the inverter (4), and/or the rectifier (5) is configured to set the transmitted electrical power via a suitable pulse pattern modulation of control signals of the rectifier (5).

2. The transmission system as claimed in claim 1,
wherein a fundamental frequency or an integer multiple of the fundamental frequency corresponds to the pulse pattern modulation of the resonant frequency of the transmitter.

3. The transmission system as claimed in claim 1,
wherein
the pulse pattern modulation of the inverter (4) and/or the rectifier (5) is configured to carry out the switching operations using a zero-voltage switching (ZVS) and/or zero-current switching (ZCS) operating mode.

4. The transmission system as claimed in claim 1,
further comprising a controller (10) coupled to the inverter (4) and the rectifier (5) and having a switching pattern (11) of predefined or variable length for the inverter (4) and/or for the rectifier (5), for a plurality of operating points of the transmission system (1), wherein each position of the switching pattern (11) indicates a half wave or a full wave of the voltage or the electric current; and
wherein the controller (10) is configured to control the inverter (4) and/or the rectifier (5) as a function of one of the switching patterns (11).

5. The transmission system as claimed in claim 4,
wherein
the controller (10) is configured to synchronize the switching of the inverter (4) and the switching of the rectifier (5).

6. The transmission system as claimed in claim 1,
wherein
the inverter (4) includes a bridge circuit; and/or
the rectifier (5) has two negative rectifier branches (14-1 to 14-2), each including a second switching element (17-1 to 17-2) including a second diode (18-1 to 18-2) which is reverse-connected in parallel to each second switching element, and two positive rectifier branches (14-3 to 14-4), each including a third diode (19-1 to 19-2), or that the rectifier (5) is an inverter identical to the inverter device (4).

7. A method for the contactless transmission of energy to a consumer (2), the method comprising:
cyclically switching (S1) electrical supply power (7) of an energy source (6) to a transmitter (3) for the contactless transmission of electrical energy;
contactlessly transmitting (S2) the electrical energy in the transmitter (3);
cyclically switching (S3) electrical power (8) provided by the transmitter (3) to the consumer (2);
wherein in at least one of the steps of cyclically switching (S1, S3), the respective power is regulated via pulse pattern modulation.

8. The method as claimed in claim 7,
wherein in both of the steps of cyclically switching, the power is regulated via pulse pattern modulation in each case.

9. The method as claimed in one of claims 7,
wherein the steps of cyclically switching, or the switching patterns, are synchronized.

10. The method as claimed in claim 7,
wherein for a plurality of operating points of the method, a switching pattern (11) having a predefined or variable length is predefined in each case for cyclically switching electrical supply power (7) of the energy source (6) and/or cyclically switching the electrical power (8) provided by the transmitter (3), wherein each position of the switching pattern (11) indicates a half wave or a full wave of the voltage or the current of the particular power; and
wherein the electrical supply power (7) of the energy source (6) is cyclically switched, and/or the power (8) provided by the transmitter (3) is cyclically switched, as a function of one of the switching patterns (11) in each case.

11. A vehicle assembly (20)
including a transmission system (1) as claimed in claim 1;
including a vehicle (25);
wherein the rectifier (5) is situated in the vehicle (25); and
wherein the inverter (4) is situated outside the vehicle (25); and
wherein the transmitter (3) is arranged at least partially in the vehicle (25) and partially outside the vehicle (25).
